(19) United States
(12) Patent Application Publication
(10) Pub. No.: US 2020/0152375 A1
(43) Pub. Date: May 14, 2020

(54) COIL FORMER FOR PRODUCING AN EDDY CURRENT SENSOR, EDDY CURRENT SENSOR AND APPARATUS IN ORDER TO WIND A COIL WIRE ONTO THE COIL FORMER FOR PRODUCING SUCH AN EDDY CURRENT SENSOR

(71) Applicant: Siemens Aktiengesellschaft, München (DE)

(72) Inventors: Michael Clossen-von Lanken Schulz, Issum (DE); Stefan Obermayr, Duisburg (DE)

(21) Appl. No.: 16/604,261

(22) PCT Filed: Mar. 14, 2018
(86) PCT No.: PCT/EP2018/056379

§ 371 Date: Oct. 10, 2019

(30) Foreign Application Priority Data
Apr. 13, 2017 (DE) 10 2017 206 368.8

(51) Int. Cl. H01F 27/30; H01F 27/24; H01F 27/28; G01N 27/90

(52) U.S. Cl. CPC H01F 27/30; G01N 27/9033; H01F 27/2823; H01F 27/24

(57) ABSTRACT

Provided is a coil former for producing an eddy current sensor having a winding head defining a longitudinal axis, in the outer surface of which winding head two circumferential grooves are formed and each extend along the entire circumference of the winding head around a winding core, wherein the circumferential grooves cross at the top side and the bottom side of the winding head at the longitudinal axis position and serve to hold a coil wire that is to be wound around the winding core in the manner of a cross-wound winding, and wherein the circumferential grooves are limited by holding webs, as seen in the circumferential direction, which holding webs extend in the longitudinal axis direction and project beyond the winding core in the direction of the two axial end regions of the coil former and in the radial direction.

### CROSS-REFERENCE TO RELATED APPLICATIONS

This application claims priority to PCT Application No. PCT/EP2018/056379, having a filing date of Mar. 14, 2018, which is based on German Application No. 10 2017 206 368.8, having a filing date of Apr. 13, 2017, the entire contents both of which are hereby incorporated by reference.

### FIELD OF TECHNOLOGY

The following relates to a coil former for producing an eddy current sensor, an eddy current sensor and a device to wind a coil wire onto the coil former for producing such an eddy current sensor.

### BACKGROUND

In axial flow machines, such as turbines or compressors, receiving grooves, which are also known as “shaft claws”, are provided equidistantly spaced along the circumference of a shaft or a wheel disk secured on the shaft and extend through the shaft or the wheel disk in the axial direction of the flow machine. In this case, the contour of the receiving grooves corresponds to the contour of the blade root to be received so that the blade roots can be inserted into the receiving grooves in the axial direction and, in the assembled state, are seated with form fit in the respective receiving groove so that, upon a rotation of the of the rotor in the radial direction of the flow machine, they are held reliably on the shaft. A sufficiently known and frequently used contour of the receiving grooves and corresponding blade roots is the so-called “fir-tree contour” as is shown in FIG. 10 and known, for example, from EP 2 282 010 A1.

During operation of the flow machine, the blades are subject to high mechanical stresses, in particular in the region of the receiving grooves, which can result in signs of fatigue and damage to the components. In particular, crack formations can appear on the components.

It is therefore necessary to regularly test the components which are subject to operating stresses, and in particular the receiving grooves of rotors, for such crack formations. Testing takes place nondestructively, wherein, owing to its high sensitivity, fluorescent magnetic particle testing is predominantly used. This test method is regarded as disadvantageous since chemical test media are used. It is therefore further deemed problematic that the test region for magnetic particle testing has to be darkened and UV light, which is harmful to humans, is used during the testing procedure. Magnetic particle testing is furthermore visual testing, which is why image-based documentation of all indicators with a record of all data for the entire shaft claw surface in digital form is difficult.

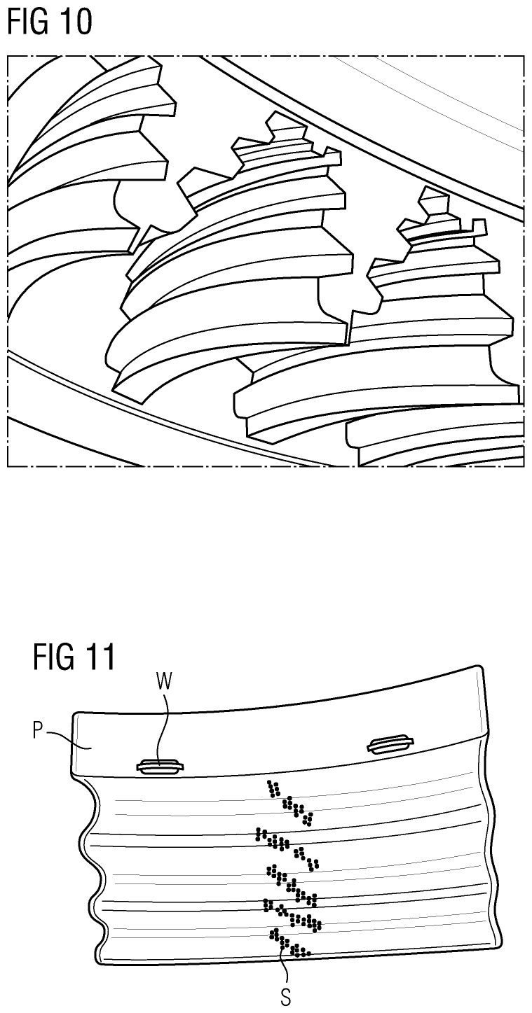

To address these problems, the eddy current test technique is alternatively developed for testing shaft claws. In this case, arrays of between 32 and 256 individual eddy current sensors S or eddy current probes are used. An SLS test piece P which has an adapted contour for testing a shaft claw and 128 individual eddy current sensors S and two integrated position encoders W is illustrated in FIG. 11.

A problem when using the eddy current technique consists in that the test sensitivity of small individual sensors in the region of highly curved contours is lower than that of fluorescent magnetic particle testing. Investigations have in fact shown that considerably larger cross-wound eddy current sensors have sufficient sensitivity in simple flat surfaces, but, owing to their overall size and shape, they cannot be brought near enough to all points to be reached within a shaft claw contour to generate a sufficiently good signal.

Furthermore, to produce cross-wound coils, two cylindrically wound coils with a 90° mutual offset are conventionally inserted inside one another and molded in plastic. However, this can lead to variations in the test performance of the individual coils since, of the two coils inserted inside one another, one is inevitably always located nearer to the test subject than the other.

The above-mentioned problems with existing eddy current sensors make it desirable to produce specially adapted eddy current sensor shapes which are shaped such that they can be brought near enough to the contour to be tested in each case within a shaft claw and whereof the windings have a high winding count and winding density.

### SUMMARY

As aspect relates to coil formers for producing an eddy current sensor having a winding head defining a longitudinal axis, in the outer surface of which two circumferential grooves are formed and extend in each case around a winding core along the entire circumference of the winding head, wherein the circumferential grooves cross at the top side and the bottom side of the winding head in the longitudinal axis position and serve for receiving a coil wire to be wound around the winding core in the manner of a cross winding, and wherein the circumferential grooves, as seen in the circumferential direction, are delimited by holding webs which extend in the longitudinal axis direction and in the direction of the two axial end regions of the winding core and protrude over the winding core in the radial direction. An eddy current sensor according to the embodiments of the invention has such a coil former, wherein a coil wire is wound around the winding core in the region of the circumferential grooves.

The embodiments of the invention therefore provide a completely new procedure for producing eddy current sensors in that a coil former having crossing circumferential grooves is firstly produced and a corresponding coil wire is then wound around the winding core in the circumferential grooves in the manner of a cross winding.

This new approach firstly enables that the crossing windings can be “interwoven” with one another to ensure a uniform spacing of the windings from the test surface. To this end, the coil wire can be laid around the winding core in the circumferential grooves which cross in particular at an angle of 90°. In this case, the coil wire is expediently wound around the winding core alternately in the one circumferential groove and the other circumferential groove, in each case in layers consisting of a predetermined number of windings. The winding procedure preferably takes place in such a way that the windings of one layer are placed in the circumferential groove such that they lie closely adjacent to one another and fill this circumferential groove over its entire width. Defined winding plies or layers are thus formed, which can be laid in an organized manner on top of one another so that the spatial requirement is minimized.

The holding webs which delimit or define the circumferential grooves are relatively narrow and can each have a contour adapted to the at least accessible point within the shaft claw. In this case the coil formers are expediently formed symmetrically in such a way that two mutually diametrically opposed holding webs have mutually corresponding cross-sections, i.e. are shaped to correspond with one another. The holding webs can likewise have an outer surface which is concavely curved in the longitudinal direction and/or the circumferential direction.

It can furthermore be expedient if one holding web or a plurality of holding webs are formed to taper towards an axial end region or both axial end regions of the winding body.

According to one embodiment of the invention, it is provided that receiving means are formed in the axially front or rear end faces of two holding elements, in particular of two mutually diametrically opposed holding elements, in which receiving means electrical connection lugs are inserted or can be inserted.

Furthermore, a receiving means for a ball of ferromagnetic material can be formed in the winding core, in particular in a crossing region of the two circumferential grooves. The magnetic field generated by the eddy current sensor can be distorted in the direction of the test region by such a ball.

To enable the coil former to be held during the winding of the coil wire, a securing pin for holding the coil former is provided on the outer side of a holding web, the coil former being separated from the holding web after the winding procedure. The securing pin can project in particular radially from the holding web. This is expedient if the winding procedure—as described further below—is carried out automatically in a winding device.

The winding body can be produced by a generative manufacturing method, in particular by a selective laser sintering method (SLS). In this case, the winding body can consist of a plastics material and/or a ceramics material.

The production of the windings on the coil former can take place manually. According to the embodiments of the invention, however, a winding device has been developed to wind a coil wire onto a coil former according to the embodiments of the invention, which winding device comprises:

a base body,

a holder, which is provided and formed on the base body to fix a coil former in a defined position and alignment of its longitudinal axis and to pivot the coil former through a predetermined angle about its longitudinal axis between two defined wire winding positions associated with the circumferential grooves of the coil former, which angle corresponds to the angular offset of the circumferential grooves of the coil former and is preferably 90°, so that, in each wire winding position, the associated circumferential groove assumes a defined winding alignment in a winding plane which includes the longitudinal axis, which winding planes coincide in both wire winding positions, and

a wire guide for the coil wire, which is formed and arranged on the base body to execute a winding movement along a circular path about a coil former fixed in the holder in a plane parallel to the winding plane and, in addition, a translatory feed movement transversely, in particular perpendicularly, to the winding plane.

In this case the holder is formed in particular to hold the coil former in such a way that its longitudinal axis is aligned vertically. Accordingly, the wire guide is then formed to be moved along a circular path in a vertical plane about a coil former fixed in the holder.

According to the embodiments of the invention, the coil former according to the embodiments of the invention is therefore fixed in the holder with a defined position and alignment of its longitudinal axis. To this end, the holder can have a receiving means into which the securing pin of the coil former can be pushed and fixed, in particular clamped, horizontally. In this case, the receiving means and the securing pin are aligned complementary to one another in such a way that the securing pin, and therefore the coil former, assumes its desired position.

The coil former is then brought into one of its two wire winding positions in which one of the two circumferential grooves lies in the winding plane or in a plane parallel thereto so that a coil wire can be wound around the winding core of the coil former in this circumferential groove. To this end, the coil wire is threaded through the wire guide and its free end is fixed on the coil former. The wire guide is then moved along the defined circular path around the coil former and the coil wire is therefore laid around the winding core. During this circular winding movement, the wire guide additionally executes a translatory feed movement so that the coil windings are laid neatly adjacent to one another in a winding ply or layer in the feed direction.

When a desired number of windings is produced in the circumferential groove, the holder is pivoted so that the coil former is rotated about its longitudinal axis into its second wire winding position. In this, the second circumferential groove assumes the desired winding position and alignment so that the coil wire can be laid around the winding core in the second circumferential groove in that the wire guide is rotated about the coil former and simultaneously executes a translatory feed movement. When a sufficient number of windings is produced in this second winding layer, which preferably corresponds to the number of windings in the first winding layer, the coil former is rotated back into its first winding position by pivoting the holder to produce a further layer of coil windings in the first circumferential groove. This procedure is repeated until a sufficient number of winding plies or layers is produced.

To execute the circular movement, the wire guide according to one embodiment of the invention is mounted on a carrier which is positioned opposite the holder for the coil former and is held on the base carrier such that it is rotatable about the axis of the circular path to be described by the wire guide and is movable in a translatory manner for executing the feed movement. In this case, at least one drive is associated with the carrier, via which the carrier is driven in a rotating manner and can be adjusted in a translatory manner for executing the feed movement.

In addition, a rotary encoder can be provided to detect the respective angular position of the carrier, wherein the rotary encoder is coupled to a central control to control the rotational movement and/or the translatory movement of the carrier and/or the pivoting movement to be executed by the holder depending on signals of the rotary encoder. To this end, the carrier expediently has an orbital wheel, which has teeth on its outer circumference with which corresponding counter teeth of the rotary encoder are in engagement.

In a further configuration of the embodiments of the invention, a reel holder is provided on the base body or on the carrier, on which reel holder a draw-off reel for the coil wire can be mounted or is mounted such that it is rotatable about a reel holder axis, which extends coaxially to the axis of the circular path to be described by the wire guide or parallel thereto. In this case, the wire guide is preferably formed in such a way that a wire inlet region of the wire guide lies in the axial region of extent of the draw-off reel and an outlet region of the wire guide lies in an axial region of extent in which a coil wire is to be wound onto a coil former.

In this exemplary embodiment, therefore, a draw-off reel is provided which serves as a reservoir for the coil wire which is wound onto the draw-off reel. During operation, the coil wire is unwound from the draw-off reel, whereby this is rotated about the reel axis. Brake means are expediently associated with the reel holder, which brake means can be brought into frictional contact with a draw-off reel held on the reel holder to brake this and thereby adjust the wire tension in the coil wire unwound from the draw-off reel.

According to one embodiment of the invention, the holder for the coil former has a frame with a C-shaped basic shape, which is held on the base body such that it is pivotable about the longitudinal axis and which is supported, in particular at its top and bottom ends, on a likewise C-shaped supporting frame which is fixed on the base body. In this case, the arrangement is such that the C-shaped holding frame is of a size such that the C-shaped frame of the holder for the coil former can be freely moved within the supporting frame. The C-shaped configuration of the frame enables the wire guide to move freely around a clamped coil former.

In this case, the frame of the holder can have teeth which engage with counter teeth of a motor to pivot the frame and therefore the holder between the winding positions, wherein the motor is preferably connected to the central control and is actuated via this.

### BRIEF DESCRIPTION

Some of the embodiments will be described in detail, with references to the following Figures, wherein like designations denote like members, wherein:

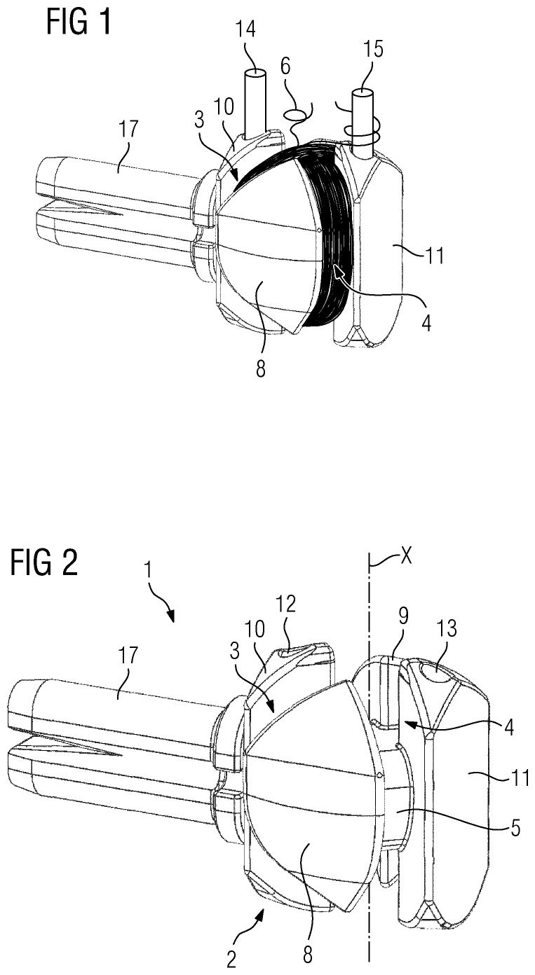

FIG. 1 depicts an eddy current sensor according to embodiments of the present invention in a perspective front view:

FIG. 2 depicts the coil former of the eddy current sensor of FIG. 1 in a perspective front view;

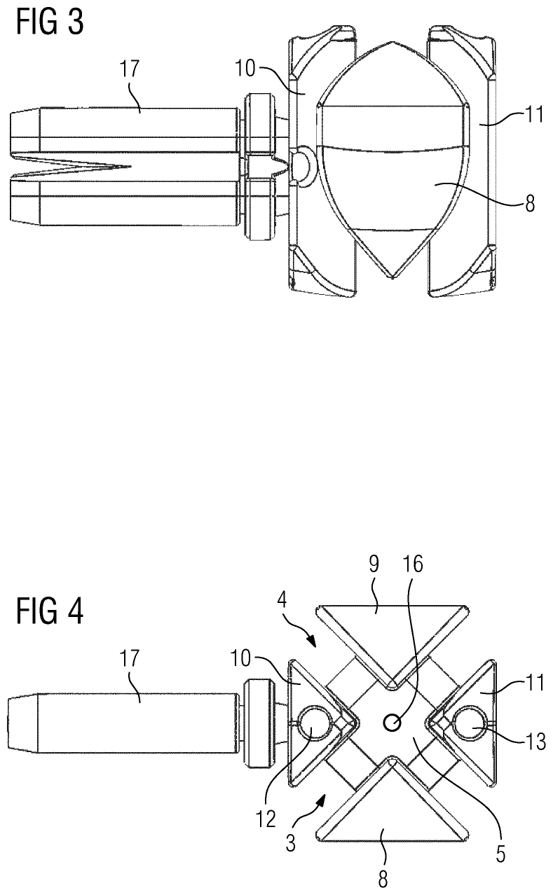

FIG. 3 depicts the coil former of FIG. 2 in a front view:

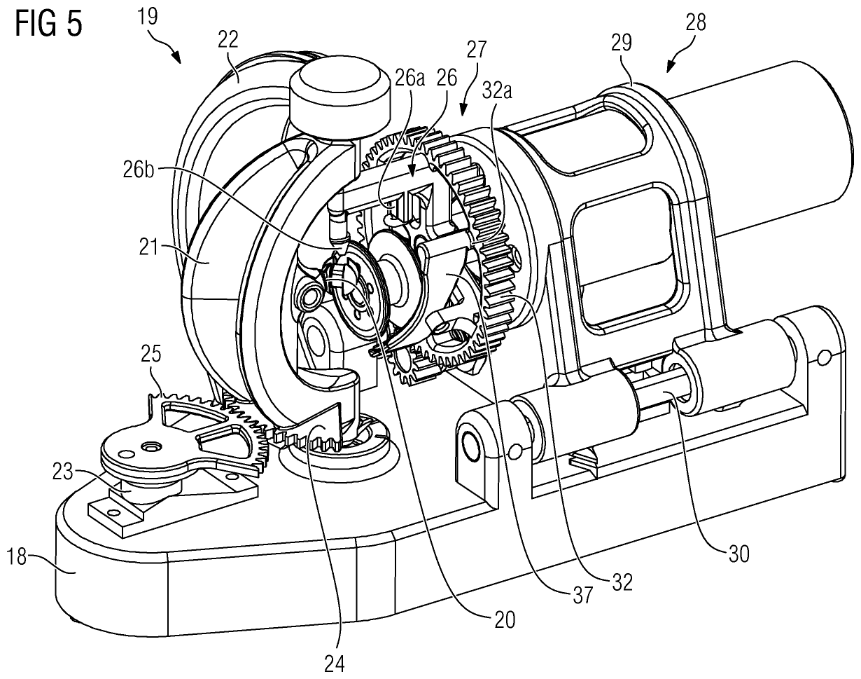

FIG. 4 depicts the coil former of FIG. 3 in a plan view;

FIG. 5 depicts a winding device for winding a coil wire onto a coil former in a perspective front view;

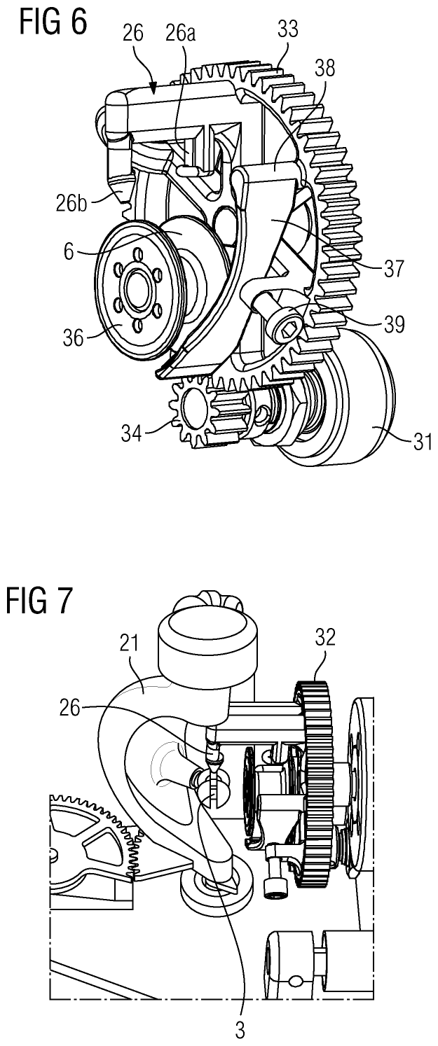

FIG. 6 depicts a detail of FIG. 5 in an enlarged illustration;

FIG. 7 t depicts an operating step of a winding procedure carried out by the winding device;

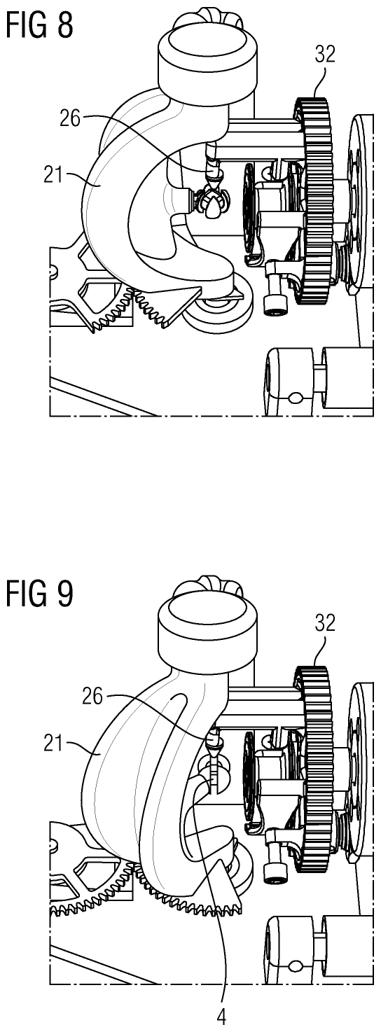

FIG. 8 depicts an operating step of a winding procedure carried out by the winding device;

FIG. 9 depicts an operating step of a winding procedure carried out by the winding device;

FIG. 10 a conventional receiving contour formed in a fir-tree shape; and

FIG. 11 a test body with eddy current sensors of the prior art provided thereon.

### DETAILED DESCRIPTION

An eddy current sensor S according to the present embodiments of the invention is illustrated in FIG. 1. This comprises a coil former 1, which is manufactured generatively according to the SLS method and consists of a plastics material. The coil former 1 has a winding head 2, which defines a longitudinal axis X of the coil former 1 and in the outer surface of which two circumferential grooves 3, 4 are formed, which each extend around a winding core 5 along the entire circumference of the winding head 2, wherein the circumferential grooves 3, 4 cross at an angle of 90° at the top side and at the bottom side of the winding head 2 in the longitudinal axis position. A coil wire 6 is wound in the circumferential grooves 3, 4 in the manner of a cross winding.

As a result of the circumferential grooves 3, 4, the coil former 1 achieves a structure with a central winding core 5, around which the coil wire 6 will be/is laid in the manner of a cross winding, and four holding webs 8, 9, 10, 11, which extend in the longitudinal axis direction and protrude over the winding core 5 both in the direction of the two axial end regions of the winding head 2 and in the radial direction. In this case, the mutually diametrically opposed holding webs 8, 9, 10, 11 are formed to correspond with one another, i.e. they have the same cross-section and the same outer shape.

The shape of the holding webs 8, 9, 10, 11 is configured to be adapted to the contour of the surface to be scanned or tested. As can be clearly seen in FIGS. 1 to 4, the holding webs 8, 9 lying at the front and rear in the illustrated exemplary embodiment are configured to be somewhat wider than the holding webs 10, 11 lying on the right and left. In this case, the front and rear holding webs 8, 9 have a concavely curved outer surface and taper, whilst the other two holding webs 10, 11, lying on the right and left, are formed to be planer or substantially planar on the outer side and have a triangular cross-sectional area over their length, wherein their bottom ends are rounded. At the top side, these right and left holding webs 10, 11 each have a receiving means 12, 13 into which electrical connection lugs 14, 15 are inserted or can be inserted.

It can be seen in FIG. 4 that a receiving means 16 is provided in the top side of the winding core 5, in which receiving means a ferromagnetic ball is bonded before the winding of the coil wire 6.

On the outer side of a holding web—here the left holding web 10—a securing pin 17 is provided, which serves to hold the coil former 1, in particular in a winding device, during the winding procedure. In the illustrated embodiment, the securing pin 17 has two cylinder pins 17a. 17b lying on top of one another so that the securing pin 17 receives an elongated cross-sectional contour in the longitudinal direction of the coil former 2 and projects radially from the holding web 10. After the current eddy sensor S has been manufactured, the securing pin 17 is removed from the holding web 10, for example by cutting.

As FIG. 1 furthermore shows, the coil wire 6 will be/is wound around the winding core 5 alternately in the one circumferential groove 3 and in the other circumferential groove 4, in each case in layers consisting of a predetermined number of windings.

FIG. 5 illustrates, in a perspective view, a winding device which serves to execute the winding procedure automatically. The winding device comprises a base body 18 on which the components of the winding device are held. In detail, the winding device comprises a holder 19, which is provided and formed on the base body 18, to hold the coil former 1 in such a way that its longitudinal axis X is aligned vertically and assumes a defined position. To this end, the holder 19 has a horizontal receiving means 20 into which the securing pin 17 of the coil former 1 can be inserted horizontally and in which it can be fixed in a clamping manner. The contour of the receiving means 20 is formed to be complementary to the elongated cross-sectional contour of the securing pin 17 of the coil former 1 so that the longitudinal axis X of the coil former 1 assumes its desired position and vertical alignment in the inserted state.

The holder 19 is formed in such a way that a coil former 1 held in the receiving means 20 to pivot through a predetermined angle about its longitudinal axis X between two defined wire winding positions associated with the circumferential grooves 3, 4 of the coil former 1, which angle corresponds to the angular offset of the circumferential grooves 3, 4 of the coil former 1 and is therefore 90°. In this case, the arrangement is such that, in each wire winding position, the associated circumferential groove 3, 4 assumes a defined angular alignment in which it lies in a vertical plane which includes, in particular, the longitudinal axis X, wherein the angular alignment corresponds in both wire winding positions.

In the illustrated embodiment, the holder 19 comprises a frame 21 with a C-shaped basic shape, which is fixed on the base body 18 and is held on the base body 18 such that it is pivotable about a pivot axis which lies coaxially to the desired position of the longitudinal axis X of a coil former 1 clamped in the receiving means 20, i.e. about a vertical axis. In the illustrated exemplary embodiment, the support of the C-shaped frame 21 is effected by a likewise C-shaped holding frame 22, whereof the bottom end is fixed on the base body 18. The C-shaped frame 21 of the holder 19 engages in the holding frame 22, wherein its free end regions are supported on the free ends of the holding frame 22. To this end, the C-shaped frame 21 of the holder 19 can have corresponding joint pins which project outwards from the end regions of the C-shaped frame 21 in the vertical direction and engage in corresponding supporting recesses of the holding frame 22.

The C-shaped frame 21 is driven by a motor for executing its pivoting movements between the winding positions. To this end, a corresponding electric motor is provided, which is arranged in the base body 18, wherein the drive shaft 23 of the electric motor projects upwards from the base body 18 and is coupled to the C-shaped frame 21. In practice, teeth 24 are provided on the frame 21, which are in engagement with corresponding counter teeth 25 provided on the drive shaft 23 of the electric motor to pivot the frame 21 and therefore the holder 19 between the wire winding positions.

The winding device furthermore comprises a wire guide 26, which is formed and arranged on the base body 18 to execute a winding movement along a circular path about a coil former 1 fixed in the holder 19 in a plane parallel to the winding plane and, in addition, a translatory feed movement transversely, here perpendicularly, to the winding plane. To this end, the wire guide 26 is mounted on a carrier 27 which positioned on the base body 18 opposite the holder 19 for the coil former 1 and aligned about the axis of the circular path to be described by the wire guide 26, i.e. coaxially to an axis Y which is defined by the receiving means of the holder, is perpendicular to the longitudinal axis X and intersects this. In addition, the wire guide 26 is held on the base carrier 18 such that it is movable in a translatory manner for executing the feed movement.

Associated with the carrier 27 is a drive 28 via which the carrier 26 can be driven in a rotating manner and adjusted in a translatory manner for executing the feed movement. It can be seen in FIG. 5 that, for executing the feed movement, the carrier 27 is linearly movably guided via a support arrangement 29 on two guide rails 30 can be adjusted via a motor (not shown) of the drive. The housing 30 of a motor for driving the carrier 27 in a rotating manner is held in the support arrangement 29, the carrier 27 being mounted on the drive shaft of said motor in a manner which is not shown.

The winding device furthermore comprises a central control to control the motors for driving the carrier 27 and the C-shaped frame 21 of the holder 19. Associated with this control is a rotary encoder 31 which is provided to detect the respective angular position of the carrier 27 and, on the basis of the respective angular position and/or the executed revolutions of the carrier 27, to control the rotational movement and the translatory movement of the carrier 27 and the pivoting movement to be executed by the holder 19 depending on signals of the rotary encoder 31. To this end, the carrier 27 has an orbital wheel 32, which has teeth 33 on its outer circumference with which corresponding counter teeth 34 of the rotary encoder 31 are in engagement (see also FIG. 6).

Finally, a reel holder 35 is provided on the carrier 27, on which reel holder a draw-off reel 36 for the coil wire 6 is rotatably mounted. In practice, the arrangement is such that the reel holder 35 is held on a spoke 32a of the orbital wheel 32 such that it is rotatable about a parallel to the axis Y defined by the receiving means 20 of the holder 19. The wire guide 26 is formed to be approximately U-shaped and defines a wire guide channel whereof the wire inlet region 26a and wire outlet region 26b are provided on the free ends of the U limbs and point inwards to the axis of rotation of the carrier 27. In this case, the wire inlet region 26a of the wire guide 26 lies in the axial region of extent of the draw-off reel 36 and the wire outlet region 26b of the wire guide 26 lies in an axial region of extent in which a coil wire 1 is to be wound onto a coil former. The length of the U web connecting the U limbs is formed accordingly.

When the carrier 27 is rotated to wind a coil wire onto a coil former 1, the coil wire is unwound by reel holder 35, whereby this is set in rotation about the axis Y. To set sufficient wire tension in the coil wire, brake means are associated with the reel holder 35, which brake means can be brought into frictional contact with the draw-off reel 36 to brake this. In the illustrated embodiment, the brake means comprise a brake web 37 which is held on the orbital wheel 32 such that it is pivotable 38 about a pivot axis parallel to the axis of rotation of the carrier 27 and can be brought into contact with the draw-off reel 36. An adjusting screw 39 is furthermore provided, which can be set against the brake web 37 from the outside to press the brake web 37 against the draw-off reel 36.

To produce an eddy current sensor, a coil former 1 having a bonded ferromagnetic ball is inserted into the receiving means 20 of the holder 19 of the winding device in a clamping manner and therefore positioned in such a way that the longitudinal axis X of the coil former 1 is aligned coaxially to the axis of rotation of the C-shaped frame 21 of the holder 19.

A draw-off reel 36 is mounted on the carrier 27 of the winding device, on which draw-off reel the coil wire 6 is wound as a reservoir. The free end of the coil wire 6 is threaded through the wire guide 26 and secured on the coil former 1 in that it is fixedly clamped in the receiving means 20 of the holder together with the securing pin 17. In this case, the carrier 27 is positioned axially such that the wire outlet region 26b of the wire guide 26 lies in the axial region of extent of the circumferential groove 3 in which the coil wire 6 is firstly to be wound. The holder 19 is furthermore brought into its first wire winding position (see FIG. 7). The carrier 27 is now driven in a rotating manner so that it moves along a circular path about the coil former 1 and the coil wire 6 is therefore wound around the winding core 5 of the coil former 1 in the circumferential groove 3. At the same time, the carrier 27 is adjusted axially via an adjustment along the guide rail 30 so that the produced coil windings come to lie adjacent to one another in the circumferential groove 3. When a desired number of mutually adjacently lying coil windings, i.e. a winding ply or layer, is produced, the holder 19 is brought into its second wire winding position in that the C-shaped frame 21 is pivoted through 90° by actuating the electric motor (see FIGS. 8 and 9). This pivoting procedure takes place when the wire outlet region 26b of the wire guide 26 is positioned precisely above or below the crossing regions of the two circumferential grooves 3, 4 of the coil former 1 so that the coil wire 6 is transferred from the one circumferential groove 3 into the other circumferential groove 4 and, in this, is wound around the winding core 5 when the wire guide 26, by actuating the carrier 27, is rotated back about the coil former 1 and, at the same time, moved in a translatory manner. To produce further winding layers, the holder is pivoted back into its first wire winding position and the process described above is repeated as often as desired.

This winding procedure is controlled automatically via the control of the winding device. To this end, signals are output via the rotary encoder 31, via which the control learns in which angular position the carrier 27 is located, i.e. how many revolutions the wire guide 26 has executed about the coil former 1, to correspondingly actuate the motor for executing the translatory feed movement of the carrier 27 and the electric motor for pivoting the holder 19 depending on the detected angular positions.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A coil former for producing an eddy current sensor comprising:
a winding head defining a longitudinal axis, in an outer surface of which two circumferential grooves are formed, and each extend around a winding core along an entire circumference of the winding head;
wherein the two circumferential grooves cross at a top side and a bottom side of the winding head in a longitudinal axis position and serve for receiving a coil wire to be wound around the winding core in a manner of a cross winding;
wherein the two circumferential grooves, as seen in a circumferential direction, are delimited by holding webs, which extend in a longitudinal axis direction and in a direction of two axial end regions of the coil former, and protrude over the winding core in a radial direction.

2. The coil former as claimed in claim 1, wherein the two circumferential grooves cross at an angle of 90°.

3. The coil former as claimed in claim 1, wherein two mutually diametrically opposed holding webs have mutually corresponding cross-sections.

4. The coil former as claimed in claim 1, wherein at least one holding web has an outer surface which is concavely curved in the longitudinal direction and/or the circumferential direction.

5. The coil former as claimed in claim 1, wherein at least one holding web is formed to taper towards an axial end region or both axial end regions of the winding head.

6. The coil former as claimed in claim 1, wherein receiving means are formed in an axially front or rear end faces of two holding elements of two diametrically opposed holding elements, in which the receiving means electrical connection lugs are inserted or can be inserted.

7. The coil former as claimed in claim 1, wherein a receiving means for a ball of ferromagnetic material is formed in the winding core in a crossing region of the two circumferential grooves.

8. The coil former as claimed in claim 1, wherein a securing pin for holding the coil former in a winding device is provided radially on the outer side of a holding web.

9. The coil former as claimed in claim 1, wherein the coil former is produced by a generative manufacturing method by a selective laser sintering method.

10. The coil former as claimed in claim 1, wherein the coil former comprises a plastics material and/or a ceramics material.

11. An eddy current sensor having a coil former as claimed in claim 1, wherein a coil wire is wound around the winding core in a region of the two circumferential grooves in the manner of a cross winding.

12. The eddy current sensor as claimed in claim 11, wherein the coil wires is wound around the winding core alternately in the one circumferential groove and the other circumferential groove, in each case in layers consisting of a predetermined number of windings.

13. The eddy current sensor as claimed in claim 11, wherein the coil wire is wound around the winding core in such a way that the coil wire lies completely within the two circumferential grooves which are defined between the holding webs.

14. A winding device for winding a coil wire onto a coil former as claimed in one of claim 1, comprising:
a base body,
a holder, which is provided and formed on the base body to fix the coil former in a defined position and alignment of a longitudinal axis and to pivot the coil former through a predetermined angle about the longitudinal axis between two defined wire winding positions associated with the two circumferential grooves of the coil former, which angle corresponds to an angular offset of the two circumferential grooves of the coil former and is 90°, so that, in each wire winding position, the associated circumferential groove assumes a defined winding alignment in a winding plane which includes the longitudinal axis, which winding planes coincide in both wire winding positions, and
a wire guide, which is formed and arranged on the base body to execute a winding movement along a circular path about the coil former fixed in the holder in a plane parallel to the winding plane and, in addition, a translatory feed movement transversely, to the winding plane.

15. The winding device as claimed in claim 14, wherein the holder is formed to hold the coil former in such a way that the longitudinal axis is aligned vertically and, accordingly, the wire guide is formed to be moved along a circular path in a vertical plane about the coil former fixed in the holder.

16. The winding device as claimed in claim 14, wherein the holder has a receiving means into which a securing pin of the coil former can be pushed and fixed horizontally in a defined alignment.

17. The winding device as claimed in claim 14, wherein the wire guide is mounted on a carrier which is positioned opposite the holder for the coil former and is held on the base carrier such that is the carrier is rotatable about the axis of the circular path to be described by the wire guide and is movable in a translatory manner for executing the feed movement.

18. The winding device as claimed in claim 14, wherein at least one drive is associated with the carrier, via which drive the carrier can be driven in a rotating manner and adjusted in a translatory manner for executing the feed movement.

19. The winding device as claimed in claim 18, wherein a rotary encoder is provided to detect the respective angular position of the carrier and the rotary encoder is coupled to a central control to control the rotational movement and/or the translatory movement of the carrier and/or the pivoting movement to be executed by the holder depending on signals of the rotary encoder.

20. The winding device as claimed in claim 19, wherein the carrier has an orbital wheel, which has teeth on its outer circumference, with which corresponding counter-teeth of the rotary encoder are in engagement.

21. The winding device as claimed in claim 14, wherein a reel holder is provided on the base body or on the carrier, on which reel holder a draw-off reel for the coil wire can be mounted or is mounted such that it is rotatable about a reel holder axis, which extends coaxially to the axis of the circular path to be described by the wire guide or parallel thereto, wherein the wire guide is formed in such a way that a wire inlet region of the wire guide lies in the axial region of extent of the draw-off reel and an outlet region of the wire guide lies in an axial region of extent in which a coil wire is to be wound onto a coil former.

22. The winding device as claimed in claim 21, wherein brake means are associated with the reel holder, which brake means can be brought into frictional contact with a draw-off reel held on the reel holder, to brake this draw-off reel and thereby adjust the wire tension in the coil wire to be supplied.

23. The winding device as claimed in claim 14, wherein the holder for the coil former has a frame with a C-shaped basic shape, which is held on the base body such that it is pivotable about the longitudinal axis and which is supported at a top end and a bottom end, on a likewise C-shaped holding frame which is fixed on the base body.

24. The winding device as claimed in claim 23, wherein the frame has teeth which are in engagement with counter teeth of a motor to pivot the frame, and therefore the holder, between the winding positions, wherein the motor is connected to the central control and actuated.
